(19) United States
(12) Patent Application Publication
(10) Pub. No.: US 2021/0203192 A1
(43) Pub. Date: Jul. 1, 2021

(54) WIRELESS POWER TRANSMISSION SYSTEM AND METHOD

(71) Applicant: Imperial College Innovations Ltd, London (GB)

(72) Inventors: Lingxin Lan, London (GB); Paul Mitcheson, London (GB); David Yates, London (GB); Samer Aldhaher, London (GB)

(21) Appl. No.: 17/058,079

(22) PCT Filed: May 30, 2019
(86) PCT No.: PCT/EP2019/064149

§ 371 Date: Nov. 23, 2020

(30) Foreign Application Priority Data
May 30, 2018 (GB) 1808844.3

(51) Int. Cl. H02J 50/60; H02J 50/12; G06N 20/00; G06N 5/04

(52) U.S. Cl. CPC H02J 50/60; G06N 5/04; G06N 20/00; H02J 50/12

(57) ABSTRACT

The present disclosure relates to a wireless power transmission system (100) comprising a wireless power transmission device (108), and a method of identifying the presence of a foreign object within wireless power transmission range of the wireless power transmission device (108). The wireless power transmission system (100) comprises a wireless power transmission device (108) for wirelessly transmitting power to an electronic receiver device (102) and a digital subsystem comprising an analog to digital converter “ADC” and a processor. The ADC is configured to digitise a waveform associated with the wireless power transmission device (108), to produce a source-drain waveform vector. The processor is configured to apply a classifier to the source-drain waveform vector; and determine, based on a numerical output of the classifier, whether a foreign object is present within wireless power transmission range of the wireless power transmission device (108).

### RELATED APPLICATIONS

The present application is a national stage application under 35 U.S.C. § 371 of International Application No. PCT/EP2019/064149, filed 30 May 2019, and which claims priority from GB Patent Application No. 1808844.3, filed 30 May 2018. The above-referenced applications are hereby incorporated by reference into the present application in their entirety.

### FIELD

The present disclosure relates to a wireless power transmission system, and a method for use with a wireless power transmission system. In particular, it relates to a method and system capable of identifying the presence of a foreign object within wireless power transmission range of a wireless power transmission device, to a high degree of accuracy.

### BACKGROUND

Wireless Power transmission (WPT) devices for wirelessly transferring power to electronic devices are known. No physical connection is required between the WPT device and the electronic device. WPT is convenient, and in certain cases even necessary. Magnetic induction WPT devices, which use magnetic fields to induce a current in nearby devices, are known.

A problem with WPT devices is that they can cause unwanted inductive heating in foreign objects located within wireless power transmission range. A foreign object is defined as an object which draws power from a WPT system and/or detunes the system with no useful output. Foreign objects are therefore sometimes referred to as parasitic objects, because currents induced in the foreign object reduce the efficiency of the system (e.g. by consuming power through Joule heating) with no useful output.

For example, if a coin is placed on a wireless power transfer device, induced eddy currents in the coin will cause the coin to heat up. This heating effect draws power which could otherwise have been used e.g. to charge an electronic device, and can cause burns if the coin is handled. There are in fact two safety concerns with WPT systems: the specific absorption rate (SAR) and the inductive heating effects of the generated magnetic and electric fields, e.g. in the coin.

It is therefore desirable to provide WPT systems capable of preventing power transfer to foreign objects, in order to improve both wireless power transfer efficiency, safety and circuit protection.

WPT systems which include additional sensors for detecting the presence of a foreign object are known. But this is an inelegant solution, which increases both cost and complexity of the system.

U.S. Pat. No. 9,735,585 provides a system which measures a power load on a transmitter device. In this system, accepted power on the system is compared with transmitted power on the system. If a difference between the accepted power and the transmitted power is above a pre-determined threshold, power may be shut off. The inventors of the present invention have found the system of U.S. Pat. No. 9,735,585 to provide low foreign object detection accuracy.

It is therefore desirable to provide a simple, low-cost WPT system which can detect foreign objects to a high degree of accuracy.

### SUMMARY

The inventors have found that it is possible to determine whether or not a foreign object is present within wireless power transfer range of a wireless power transfer device by observing a voltage waveform associated with the wireless power transfer device. Moreover, the inventors have found that the it is possible to make such a determination to a high level of accuracy and confidence, by analysing the voltage waveform.

Hence, stated generally, the present disclosure provides a method and a system for detecting the presence of a foreign object within wireless power transfer range of a wireless power transfer device, based on analysis of a voltage waveform associated with the wireless power transfer device.

In a first aspect, there is provided a method for identifying the presence of a foreign object within wireless power transmission range of the wireless power transmission device, the method comprising: supplying power to a wireless power transmission device; measuring a waveform associated with the wireless power transmission device; determining, based on the waveform, whether a foreign object is present within wireless power transmission range of the wireless power transmission device.

The waveform may be a voltage waveform. But as the skilled person will appreciate, it can equally be a current waveform. Therefore, the present disclosure encompasses waveforms of either type. However, for brevity and for clarity, a voltage waveform will be described hereafter. But as the reader will appreciate, where voltage is referred to, it could equally be substituted with current.

This method does not require looking at a feedback loop between a wireless power receiver and a wireless power transmitter. It is therefore of improved simplicity, i.e. reduced design complexity. No feedback loop between a transmitter and a receiver is required.

Optional features of the first aspect are set out below.

As discussed above, a foreign object may alternatively be referred to as a parasitic object, e.g. an object in which parasitic currents may be induced.

The wireless power transmission device may be an inductive power transmission device, e.g. for inductively transmitting power to an electronic receiver device.

The voltage waveform may be a source-drain drain voltage waveform. The source-drain voltage waveform may be measured at a drain of a transistor associated with the wireless power transmission device. The transistor may be part of an inverter supplying alternating current “AC” power to the wireless power transmission device, e.g. an inverter supplying AC power to an induction coil of the wireless power transmission device. As the skilled person will appreciate, the voltage waveform could be measured at other points (other than the transistor drain) within the inverter.

Alternatively, the voltage waveform may be measured within an inverter associated with the wireless power transmission device, e.g. at an arbitrary location within the inverter. The inverter may be an EF-Class inverter. Alternatively it may be an E-Class inverter.

The voltage waveform may be digitized to produce a voltage waveform vector (e.g. source-drain voltage waveform vector, in cases where the voltage waveform is the source-drain waveform vector), and a classifier may be applied to the voltage waveform vector. Accordingly, determining whether a foreign object is present within wireless power transmission range of the wireless power transmission device may be based on a numerical output of the classifier. In other words, the method may determine, based on the numerical output (which corresponds to the voltage waveform), whether a foreign object is present within wireless power transmission range of the wireless power transmission device. The classifier may be predefined, e.g. through a machine learning process (e.g. the machine learning process of the third aspect). Alternatively, it may be calculated/calibrated/recalibrated ‘in the field’. The classifier may thus be a machine learning classifier. The classifier may be linear.

In some examples, the voltage waveform may be digitized at a sampling frequency that is at least double the fundamental frequency of voltage waveform. In this way, there will be at least two digital data points for each cycle of the voltage waveform.

In other examples, the voltage waveform may be digitized at a sampling frequency that is less than double the fundamental frequency of the voltage waveform (provided that it is not exactly equal to the frequency of the voltage waveform). For example, the voltage waveform could be digitized at a sampling frequency that is greater than, or less than, the fundamental frequency of the voltage waveform. In such examples, there may be one or fewer digital data points for each cycle of the voltage waveform.

Provided that the classifier has been obtained (or ‘learned’) using the same timing to digitise the voltage waveform in the first aspect, it will be possible to accurately determine whether or not a foreign object is present by applying the classifier to the voltage waveform vector.

The numerical output may be calculated by taking the inner product of the voltage waveform vector and a weight vector and adding a bias value to the to the inner product of the voltage waveform vector and the weight vector. Collectively, the weight vector and the bias value may be considered as the classifier.

Used herein, a (linear) classifier is a line (in two dimensions), plane (in three or more dimensions), or hyperplane (in three or more dimensions), which separates a set of data into two groups. Data points on a first side of the line/plane/hyperplane belong to a first group, and data points on a second side of the line/plane/hyperplane belong to a second group. Points on a first side of the line may be classified as “no foreign object present”, and points on a second side of the line may be classified as “foreign object present”. The line/plane/hyperplane may be predefined according to a training set of voltage waveform vectors, e.g. through a machine learning process. Alternatively, it may be calculated/calibrated/recalibrated ‘in the field’ e.g. using a machine learning process.

The weight vector may define a line/plane/hyperplane which separates the data points into a first group (e.g. a “no foreign object present” group), and a second group (e.g. a “foreign object present” group). The weight vector may be predefined according to a training set of voltage waveform vectors, e.g. through a machine learning process. Alternatively, it may be calculated/calibrated/recalibrated ‘in the field’ e.g. using a machine learning process.

The bias value is a scalar, and defines an offset of the line/plane/hyperplane from the origin in a vector space (i.e. a vector space corresponding to the weight vector and/or the voltage waveform vector). The bias value may be predefined according to a training set of voltage waveform vectors, e.g. through a machine learning process. Alternatively, it may be calculated/calibrated/recalibrated ‘in the field’ e.g. using a machine learning process.

Determining whether a foreign object is present within wireless power transmission range of the wireless power transmission device may be based on the sign of the numerical output. In other words, the method may determine, based on the sign of the numerical output (which is related to the voltage waveform), whether a foreign object is present within wireless power transmission range of the wireless power transmission device. For example, if the numerical output of the classifier is positive, then it may be determined that there is a foreign object present. If the numerical output of the classifier is negative, then it may be determined that there is no foreign object present.

In effect, determining whether a foreign object is present within wireless power transmission range of the wireless power transmission device may comprise plotting the voltage waveform vector on a corresponding vector space (i.e. a vector space having the same dimensionality as the voltage waveform vector), and identifying that a foreign object is present if the voltage waveform vector lies on a first side of a predefined line/plane/hyperplane in the vector space.

The voltage waveform vector may be at least one dimensional, or may be at least two-dimensional. The weight vector may be at least one dimensional, or may be at least two-dimensional. The voltage waveform vector may have the same dimensionality as the weight vector.

The voltage waveform vector may include a first component corresponding to a voltage value of a first peak of the voltage waveform; and a second component corresponding to a voltage value of a second peak of the voltage waveform adjacent to the first peak.

In response to determining that a foreign object is present within wireless power transmission range of the wireless power transfer device, the method may reduce a power supply to the wireless power transmission device. Alternatively, in response to determining that a foreign object is present within wireless power transmission range of the wireless power transfer device, the method may substantially reduce (e.g. reduce to an idle state) a power supply to the wireless power transmission device. Alternatively, in response to determining that a foreign object is present within wireless power transmission range of the wireless power transfer device, the method may shut off (e.g. switch off) a power supply to the wireless power transmission device.

In a second aspect there is provided a wireless power transmission system for performing the method of the first aspect. The wireless power transmission system comprises a wireless power transmission device for wirelessly transmitting power to an electronic receiver device, and a (digital) subsystem configured to perform the method of the first aspect.

In particular, in the second aspect there is provided a wireless power transmission system, comprising: a wireless power transmission device for wirelessly transmitting power to a receiver device; and a digital subsystem configured to: measure a waveform associated with the wireless power transmission device; and determine, based on the waveform, whether a foreign object is present within wireless power transmission range of the wireless power transmission device.

As with the first aspect, the waveform could be a voltage waveform or a current waveform. But a voltage waveform only will be described below for clarity and for brevity.

Optional features of the second aspect are set out below.

The digital subsystem may comprise an analog to digital converter “ADC” configured to digitise the voltage waveform to produce a voltage waveform vector, and a processor (i.e. device/component capable of performing computations, e.g. computer) configured to apply a classifier to the voltage waveform vector, wherein determining whether a foreign object is present within wireless power transmission range of the wireless power transmission device is based on a numerical output of the classifier (which corresponds to the voltage waveform).

In some examples, the ADC may digitize the voltage waveform at a sampling frequency that is at least double the fundamental frequency of voltage waveform. In this way, there will be at least two digital data points for each cycle of the voltage waveform.

In other examples, the ADC may digitize the voltage waveform at a sampling frequency that is less than double the fundamental frequency of the voltage signal (provided that the interval between each sampling point does not equal the period or integer multiples of the period of the voltage signal). For example, the voltage waveform could be digitized at a sampling frequency that is greater than, or less than, the fundamental frequency of the voltage waveform. In examples in which the ADC digitises the voltage waveform at a sampling frequency that is less than that of the fundamental frequency of the voltage waveform, there will be fewer than one digital data point for each cycle of the voltage waveform. This is advantageous, because ADCs operable at high sample rates are expensive. Reducing the sample rate at which the ADC is to operate therefore reduces the unit cost of the wireless power transmission system.

Provided that the classifier has been obtained (or ‘learned’) using the same timing to digitise the voltage waveform in the first aspect, it will be possible to accurately determine whether or not a foreign object is present by applying the classifier to the voltage waveform vector.

The processor may be configured to execute the method steps of the first aspect.

The processor of the second aspect may be configured to calculate the numerical output by calculating the inner product of the voltage waveform vector and a weight vector, and adding a bias value to the to the inner product of the voltage waveform vector and the weight vector.

The wireless power transmission device may be an inductive power transmission device for inductively transmitting power to an electronic receiver device.

The voltage waveform may be a source-drain voltage waveform. The system may further comprise a transistor associated with the wireless power transmission device, wherein the source-drain voltage waveform is measured at a drain of the transistor. In this case, the ADC may be configured to digitise the drain-source voltage waveform to produce a drain-source voltage waveform vector.

An inverter may be configured to supply power (e.g. AC power) to the wireless power transmission device. The inverter may include the transistor. The inverter may be an EF-Class inverter. Alternatively, it may be an E-Class inverter.

Alternatively, the voltage waveform may be measured within an inverter associated with the wireless power transmission device, e.g. at an arbitrary location within the inverter (which may or may not be a drain of a transistor in the inverter).

The subsystem (or computer) may further be configured to: in response to determining that a foreign object is present within wireless power transmission range of the wireless power transfer device, reduce a power supplied to the wireless power transmission device (e.g. by the inverter). Alternatively, the power supplied may be substantially reduced (e.g. reduced to an idle state) in response to determining that a foreign object is present within wireless power transmission range of the wireless power transfer device. Alternatively, the power supplied may be shut off (e.g. switched off) entirely in response to determining that a foreign object is present within wireless power transmission range of the wireless power transfer device.

In a third aspect, there is provided a method of obtaining a classifier (e.g. predefined classifier) for use in the first or second aspect. Moreover, the third aspect provides a method of obtaining a classifier (e.g. predefined classifier) for use in identifying the presence of a foreign object within wireless power transmission range of a wireless power transmission device, the method comprising: a) obtaining a training set of voltage waveform vectors (e.g. source-drain waveform vectors), each voltage waveform vector corresponding to a voltage waveform, and each voltage waveform vector being classified as foreign object present, or no foreign object present, as appropriate; b) defining a line/plane/hyperplane which separates the first and second groups in a vector space corresponding to the training set. In other words, the line/plane/hyperplane is defined according to the training set.

In an alternative aspect, a current waveform is used rather than a voltage waveform.

Optional features of the third aspect are set out below.

The vector space may have the same dimensionality as the voltage waveform vector(s) and the weight vector.

Obtaining the training set of voltage waveform vectors may comprise: a1) supplying power to a wireless power transmission device; a2) placing a foreign object either within wireless power transmission range of the wireless power transmission device, or outside of wireless power transmission range of the wireless power transmission device; a3) measuring a voltage waveform associated with the wireless power transmission device; a4) converting the voltage waveform into a voltage waveform vector, and classifying the voltage waveform vector as foreign object present, or no foreign object present as appropriate; a5) repeat steps a1) to a4) a plurality of times, to obtain the training set of voltage waveform vectors.

The method may further comprise digitizing the voltage waveforms to form the voltage waveform vectors. The voltage waveform vectors may be stored in a computer in their respective groups. In other words, the voltage waveforms for which the foreign object was positioned outside of the outside of wireless power transmission range of the wireless power transmission device may be digitized to voltage waveform vectors, classified as “no foreign object present”, and stored as a first group. Similarly, the voltage waveforms for which the foreign object was positioned within the outside of wireless power transmission range of the wireless power transmission device may be digitized to voltage waveform vectors, classified as “foreign object present”, and stored as a second group.

The voltage waveform may be a drain voltage waveform. The voltage waveform may be measured at a drain of a transistor associated with the wireless power transmission device. The transistor may be part of an inverter supplying power to the wireless power transmission device.

Alternatively, the voltage waveform may be measured within an inverter associated with the wireless power transmission device, e.g. at an arbitrary location within the inverter.

The method may further comprise defining a weight vector and bias value which describe the line/plane/hyperplane.

The weight vector is a line/plane/hyperplane which separates the data points into the first group (“no foreign object present” group), and the second group (“foreign object present” group). In other words, the weight vector may be defined according to the training set.

The bias value is a scalar, and defines an offset of the line/plane/hyperplane from the origin in the vector space. In other words, the bias value may be defined according to the training set.

The voltage waveform vectors may be at least one dimensional, or may be at least two-dimensional. The weight vector may be at least one dimensional, or may be at least two-dimensional. The voltage waveform vectors may have the same dimensionality as the weight vector.

Each voltage waveform vector may include a first component corresponding to a voltage value of a first peak of the corresponding voltage waveform; and a second component corresponding to a voltage value of a second peak of the corresponding voltage waveform adjacent to the first peak.

The voltage waveforms may be measured at a drain of a transistor associated with the wireless power transmission device. The transistor may be part of an inverter supplying power to the wireless power transmission device.

The method of obtaining the training set may be automated. In other words, steps a1) through to a5) may be automated.

In a fourth aspect, there is provided a computer-readable storage medium comprising instructions which, when executed by a computer, cause the computer to carry out the first aspect and/or the third aspect.

### BRIEF DESCRIPTION OF THE FIGURES

A preferred embodiment will now be described with reference to the accompanying figures, in which:

FIG. 1 is a circuit diagram of a wireless power transmission system, an a nearby electronic receiver device.

FIG. 2 shows a sample source-drain waveform as viewed on an oscilloscope with a foreign object present.

FIG. 3 shows sample source-drain waveforms as viewed on an oscilloscope with a foreign object present, and sample source-drain waveforms as viewed on an oscilloscope with no foreign object present.

FIG. 4 shows a training dataset consisting of n source-drain waveform vectors.

FIG. 5 shows a flow chart of the steps involved in determining/calculating a classifier.

FIG. 6 shows a flow chart of the steps involved in determining whether a foreign object is present.

### DETAILED DESCRIPTION

As used herein, computer is intended to have a broad definition. It includes a desktop PC, laptop PC, integrated circuit board, printed circuit board, processor, microprocessor, microchip, or any other component capable of performing computations.

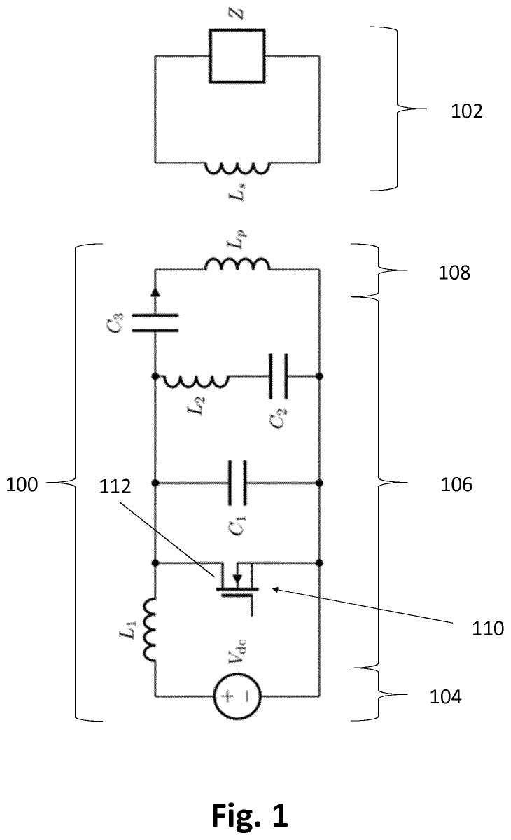

FIG. 1 is a circuit diagram of a wireless power transmission system 100 of the present invention, and a nearby electronic receiver device 102.

The wireless power transmission system 100 includes a DC power supply 104, inverter 106 and a Qi inductive wireless power transmission device 108. For illustrative purposes, the Qi inductive wireless power transmission device is shown as a simple induction loop. As the skilled person understands, the invention is suitable for use with any inductive wireless power transmission device. A Qi device is merely specified to put the invention into context.

Electronic receiver device 102 is illustrated within wireless power transfer range of the wireless power transfer device 108.

Electronic receiver device 102 is illustrated as an inductor coil Lₛ coupled to a load Z. A foreign object can be illustrated in a similar way, but the impedance of the load in a foreign object is different from the impedance of the load in an electronic receiver device. It is this difference in impedance that enables foreign objects to be detected.

In fact, the impedance of a tuned electronic receiver device behaves as a resistive load, while a foreign object (which is not tuned to the wireless power transmission device/system) may behave as either a capacitive load, or an inductive load. The source-drain waveform responds differently to these different load types.

The components of the inverter are coupled in parallel between the DC power supply 104 and the wireless power transmission device 108. The inverter comprises a first inductor L₁, a transistor 110, e.g. MOSFET transistor, having a drain 112, a first capacitor C₁, a second capacitor C₂, a second inductor L₂ and a third capacitor C₃. The inverter 106 is an EF-Class inverter, configured to provide a stable AC power supply to the wireless power transfer device regardless of load condition. It is described in more complete detail in US2017/0324277, the contents of which is incorporated herein in its entirety. The inverter operates at 13.56 MHz, and maintains zero voltage switching (ZVS) operation, and inherently regulates current amplitude and phase if the receiver is tuned to 13.56 MHz, i.e. reflecting a resistive load. An E-Class inverter could alternatively be used. As the skilled person understands, a range of different inverters could alternatively be used.

The inventors have found that a source-drain voltage waveform observed at the drain 112 provides a reliable, high-accuracy indication of the type of object (e.g. type of load Z) to which power is being transmitted. It is therefore possible to determine whether or not power is being supplied to a foreign object, by observing properties of the drain voltage waveform.

Thus, an oscilloscope, e.g. Lecroy HD4096 oscilloscope (not shown), may be connected to the drain 112 of the transistor 110 (e.g. MOSFET transistor) to measure the source-drain voltage waveform, and an analog-to-digital (ADC) converter (not shown) may be connected to the oscilloscope for digitizing the source-drain voltage waveform. This source-drain voltage waveform is then sent to a computer (not shown), for further processing and analysis. The oscilloscope may be dispensed with—it is only needed to observe the waveform(s). The signals could be digitised without the use of an oscilloscope.

The ADC may sample the voltage waveform at a frequency lower than that of the source-drain voltage waveform. In particular, a switching signal from the transistor 110 may pass through a clock divider (e.g. a ‘divide by four’ clock divider), before being passed to the microprocessor, thereby generating a slower version of the switching signal. The microprocessor thereby controls the ADC to sample the source-drain waveform at a sample rate having a frequency that is a lower than that of the switching signal. For example, where the switching signal is 20 Hz and a divide by four clock divider is used, the ADC will sample the source-drain voltage at a frequency of 5 Hz.

In order to accurately determine whether or not a given source-drain voltage waveform is indicative of the presence of a foreign object within wireless power transfer range of the wireless power transfer device, the inventors use linear support vector machine (SVM) machine learning.

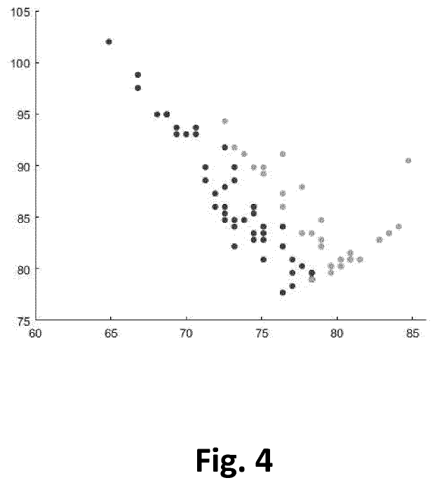

Linear SVM can be used in situations where a population of data is classified into two groups, which are separated in a vector space by a straight line. As shown in FIG. 4 (which is discussed in more detail below), the inventors have found that “no foreign object present” and “foreign object present” source-drain waveform vectors in the present case are separated into two distinct groups by a straight line. Linear SVM can therefore be employed in the present case.

The first step, having determined that linear SVM can be used, is to determine a classifier, i.e. the classifier discussed in the first, second, third and fourth aspects (above).

The following discussion focusses on an example in which the vectors used are two-dimensional. However, as the skilled person understands, the invention could be implemented with one-dimensional vectors, or higher-dimensional peaks.

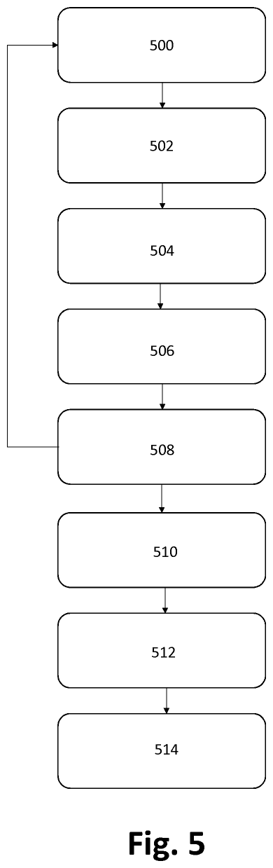

FIG. 5 shows the steps involved in determining/calculating a classifier.

At step 500, AC power is supplied to the wireless power transmission device 108, using the DV power supply 104 and the inverter 106.

At step 502, a foreign object is placed either within wireless power transmission range of the wireless power transmission device, or outside of wireless power transmission range of the wireless power transmission device.

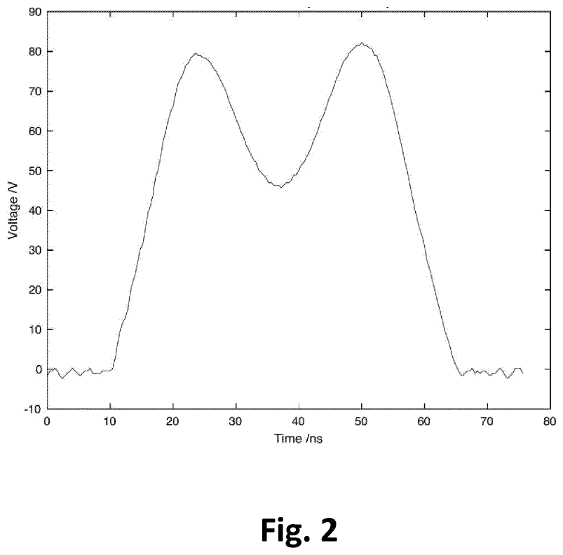

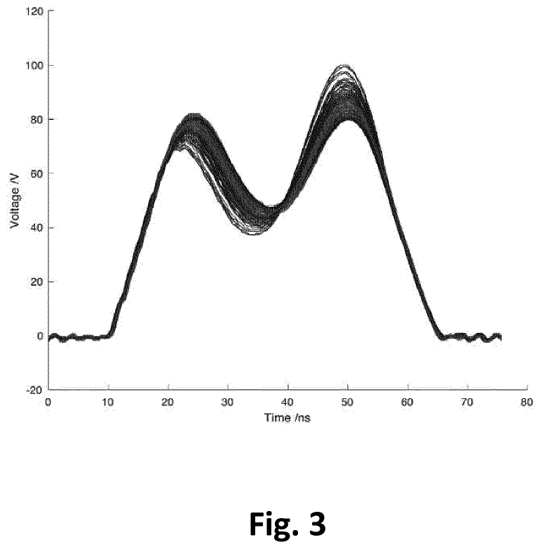

At step 504, a source-drain voltage waveform at the drain 112 of the transistor 110 is measured at the oscilloscope (not shown). FIG. 2 shows an oscilloscope trace of a single source-drain voltage waveform. FIG. 3 shows an oscilloscope trace comprising a plurality of superimposed oscilloscope traces. As can clearly be seen, each oscilloscope trace comprises two distinct peaks.

At step 506, the source-drain voltage waveform is converted into a source-drain waveform vector, by an ADC (not shown) and a computer (also not shown). As the skilled person will appreciate, the source-drain waveform vector can be two dimensional, three dimensional, or higher dimensional. In the present exemplary example, the source-drain waveform vector is two-dimensional, for simplicity of explanation and illustration. The output of the ADC is a chronological stream of numbers, corresponding to voltage values of an oscilloscope trace. Each component of the source-drain waveform vector comprises a single voltage value output from the ADC, selected by the computer as required. In the present example, each components of the two-dimensional vector corresponds to the voltage value of a respective peak in an oscilloscope trace.

At step 506, each source-drain waveform vector is also classified as foreign object present, or no foreign object present, as appropriate. The source-drain waveform vectors are then stored in a storage medium, in their two groups.

Steps 500-506 are repeated n times, until a training set comprising a sufficient number of classified source-drain waveform vectors has been acquired.

At step 508, the classified source-drain waveform vectors are plotted on their vector space. FIG. 4 shows the n source-drain waveform vectors, plotted in their two-dimensional vector space. A clear grouping of the “no foreign object present” and the “foreign object present” vectors can be seen. Once plotted in their vector space, the computer defined a line which separates the two groups.

Finally at step 512, the computer calculates a weight vector, which is a vector in a direction normal to (i.e. perpendicular to) the gradient of the line. The computer also calculates a bias value, which is a value of an offset of the line from the origin in the vector space.

The weight vector and offset value are stored in a storage medium. It is the weight vector and the bias value that are used for real-time classification of unclassified source-drain voltage waveforms. As the skilled person will appreciate, the weight vector and bias value will vary dependent on the type of wireless power transmission device (a Qi device representing one type of wireless power transmission device). They are generally determined/calculated in the factory, and then provided on a storage medium as a pre-defined weight vector and bias value, that are generally specific to the wireless power transmission device type. For some device types, the properties of the classifier may be the same.

In some situations, the classifier (e.g. weight vector and bias value) may be calibrated/recalibrated in the field).

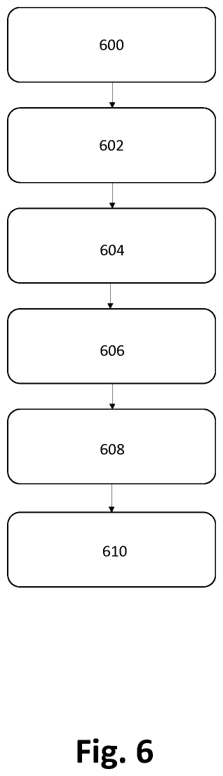

Real-time foreign object detection/determination, e.g. as discussed in the first and second aspects, will now be described with reference to FIG. 6.

At step 600, power is supplied to the wireless power transmission device 108, by the DC power supply 104 and the inverter 106.

At step 602, a source-drain voltage waveform associated with the wireless power transmission device is measured.

At step 604, the source-drain voltage waveform is converted into a two-dimensional source-drain waveform vector using the ADC and the computer (using the same techniques as described for step 506).

At step 606, the computer applies the classifier to the source-drain waveform vector, by calculating the inner product (sometimes referred to as the scalar product, or dot-product) of the source-drain waveform vector and the weight vector, and then adds the inner product to the bias value to give a scalar numerical output value.

At step 608, the computer determines, based on the numerical output value, whether or not a foreign object is present within wireless power transmission range of the wireless power transmission device. If the numerical output value is +1 (or greater), then it is determined that a foreign object is present.

At step 610, the computer shuts off/switches off power to the wireless power transmission device 108, if it is determined that a foreign object is present.

Using the machine learning process of FIG. 5, and the classification process of FIG. 6, the inventors have achieved foreign object detection accuracies of 79%. Using higher dimensional analysis, they have achieved accuracies of over 90%.

Further examples of the present disclosure are provided in the following numbered clauses.

Clause 1. A method of identifying the presence of a foreign object within wireless power transmission range of a wireless power transmission device, the method comprising: supplying power to the wireless power transmission device; measuring a voltage waveform associated with the wireless power transmission device; determining, based on the voltage waveform, whether a foreign object is present within wireless power transmission range of the wireless power transmission device.

Clause 2. The method of clause 1, wherein the voltage waveform is measured at a drain of a transistor associated with the wireless power transmission device.

Clause 3. The method of clause 1 of clause 2, further comprising digitizing the voltage waveform to produce a drain waveform vector, applying a classifier to the drain waveform vector, wherein determining whether a foreign object is present within wireless power transmission range of the wireless power transmission device is based on a numerical output of the classifier.

Clause 4. The method of clause 3, wherein the numerical output is calculated by taking the inner product of the drain waveform vector and a weight vector and adding a bias value to the to the inner product of the drain waveform vector and the weight vector.

Clause 5. The method of clause 3 or clause 4, wherein determining whether a foreign object is present within wireless power transmission range of the wireless power transmission device is based on the sign of the sign of the numerical output.

Clause 6. The method according to clause 4, wherein the drain waveform vector and the weight vector are each at least two-dimensional.

Clause 7. The method of any of clauses 3 to 6, wherein the drain waveform vector includes a first component corresponding to a voltage value of a first peak of the voltage waveform; and a second component corresponding to a voltage value of a second peak of the voltage waveform adjacent to the first peak.

Clause 8. The method of any preceding clause, further comprising: in response to determining that a foreign object is present within wireless power transmission range of the wireless power transfer device, reducing a power supply to the wireless power transmission device.

Clause 9. A wireless power transmission system, comprising: a wireless power transmission device for wirelessly transmitting power to an electronic receiver device; and a subsystem configured to: measure a voltage waveform associated with the wireless power transmission device; and determine, based on the voltage waveform, whether a foreign object is present within wireless power transmission range of the wireless power transmission device.

Clause 10. The system of clause 9, wherein the digital subsystem comprises an analog to digital converter “ADC” configured to digitise the voltage waveform to produce a drain waveform vector, and a computer configured to apply a classifier to the drain waveform vector, wherein a numerical output of the classifier provides the indication.

Clause 11. The system of clause 9 or clause 10, wherein the wireless power transmission device is an inductive power transmission device for inductively transmitting power to an electronic receiver device.

Clause 12. The system of any of clause 9 to 11, further comprising a transistor associated with the wireless power transmission device, wherein the voltage waveform is measured at a drain of the transistor.

Clause 13. The system of clause 12, further comprising an inverter configured to supply power to the wireless power transmission device, wherein the inverter includes the transistor.

Clause 14. The system of any of clauses 9 to 13, wherein the subsystem is further configured to: in response to determining that a foreign object is present within wireless power transmission range of the wireless power transfer device, reduce a power supply to the wireless power transmission device.

Clause 15. A method of obtaining a classifier for use in identifying the presence of a foreign object within wireless power transmission range of a wireless power transmission device, the method comprising:

a) obtaining a training set of drain waveform vectors, each drain waveform vector corresponding to a voltage waveform, and each drain waveform vector being classified as foreign object present, or no foreign object present, as appropriate;

b) and defining a line/plane/hyperplane which separates the first and second groups in a vector space corresponding to the training set.

Clause 16. The method of clause 15, wherein obtaining the training set of drain waveform vectors comprises:

a1) supplying power to the wireless power transmission device;

a2) placing a foreign object either within wireless power transmission range of the wireless power transmission device, or outside of wireless power transmission range of the wireless power transmission device;

a3) measuring a voltage waveform associated with the wireless power transmission device;

a4) converting the voltage waveform into a drain waveform vector, and classifying the drain waveform vector as foreign object present, or no foreign object present as appropriate;

a5) repeat steps a1) to a4) a plurality of times, to obtain the training set of drain waveform vectors.

Clause 17. The method of clause 15 or clause 16, wherein the method further comprises digitizing the voltage waveforms to form the drain waveform vectors.

Clause 18. The method of clause 16 or clause 17, further comprising defining a weight vector and bias value which describe the line/plane/hyperplane.

Clause 19. The method of any one of clauses 15 to 18, wherein the method obtaining the training set is automated.

Clause 20. A computer-readable storage medium comprising instructions which, when executed by a computer, cause the computer to carry out the steps of any of clauses 1-7 and 15-19.

Variations and modifications will be apparent to the skilled person. Such variations and modifications may involve equivalent and other features which are already known and which may be used instead of, or in addition to, features described herein. Features that are described in the context of separate examples may be provided in combination in a single embodiment. Conversely, features which are described in the context of a single example may be also provided separately or in any suitable sub-combination.

1. A method of identifying the presence of a foreign object within wireless power transmission range of a wireless power transmission device, the method comprising:
supplying power to the wireless power transmission device;
measuring a waveform associated with the wireless power transmission device;
digitizing the waveform to produce a waveform vector;
applying a classifier to the waveform vector; and
determining, based on a numerical output of the classifier, whether a foreign object is present within wireless power transmission range of the wireless power transmission device.

2. The method of claim 1, wherein the waveform is a drain-source waveform, measured at a drain of a transistor associated with the wireless power transmission device.

3. The method of claim 2, wherein the transistor is part of an inverter of the wireless power transmission device, the inverter supplying alternating current “AC” power to the wireless power transmission device.

4. The method of claim 1, wherein the numerical output is calculated by taking the inner product of the waveform vector and a weight vector and adding a bias value to the to the inner product of the waveform vector and the weight vector.

5. The method of claim 1, wherein determining whether a foreign object is present within wireless power transmission range of the wireless power transmission device is based on the sign of the numerical output.

6. The method of claim 4, wherein the waveform vector and the weight vector are each at least two-dimensional.

7. The method of claim 1, wherein the waveform vector includes a first component corresponding to a value of a first peak of the waveform; and a second component corresponding to a value of a second peak of the waveform adjacent to the first peak.

8. The method of claim 1, further comprising: in response to determining that a foreign object is present within wireless power transmission range of the wireless power transfer device, reducing a power supply to the wireless power transmission device.

9. A wireless power transmission system, comprising:
a wireless power transmission device for wirelessly transmitting power to an electronic receiver device; and
a digital subsystem comprising an analog to digital converter “ADC” and a processor;
wherein the ADC is configured to digitise a waveform associated with the wireless power transmission device to produce a waveform vector; and
the processor is configured to:
apply a classifier to the waveform vector; and
determine, based on a numerical output of the classifier, whether a foreign object is present within wireless power transmission range of the wireless power transmission device.

10. The system of claim 9, wherein the wireless power transmission device is an inductive power transmission device for inductively transmitting power to an electronic receiver device.

11. The system of claim 9, further comprising a transistor associated with the wireless power transmission device, wherein the waveform is a drain-source waveform measured at a drain of the transistor.

12. The method of claim 11, wherein the transistor is part of an inverter of the wireless power transmission device, the inverter configured to supply alternating current “AC” power to the wireless power transmission device.

13. The system of claim 11, further comprising an inverter configured to supply power to the wireless power transmission device, wherein the inverter includes the transistor.

14. The system of claim 9, wherein the digital subsystem is further configured to: in response to determining that a foreign object is present within wireless power transmission range of the wireless power transfer device, reduce a power supply to the wireless power transmission device.
